(19) United States
(12) Patent Application Publication
(10) Pub. No.: US 2013/0298175 A1
(43) Pub. Date: Nov. 7, 2013

(54) CONSTRUCTING A CUSTOMIZED MESSAGE IN A VIDEO-ON-DEMAND SERVICE

(71) Applicants: Dakshi Agrawal, Monsey, NY (US); Vasileios Pappas, Elmsford, NY (US); Mudhakar Srivatsa, White Plains, NY (US); Dinesh C. Verma, New Castle, NY (US)

(72) Inventors: Dakshi Agrawal, Monsey, NY (US); Vasileios Pappas, Elmsford, NY (US); Mudhakar Srivatsa, White Plains, NY (US); Dinesh C. Verma, New Castle, NY (US)

(73) Assignee: INTERNATIONAL BUSINESS MACHINES CORPORATION, Armonk, NY (US)

(21) Appl. No.: 13/461,934

(22) Filed: May 2, 2012

(51) Int. Cl. H04N 21/27

(52) U.S. Cl. 725/93

(57) ABSTRACT

A method, system and computer program product for creating a customized message in a video-on-demand service, in which a user accesses the service using a communications device. In an embodiment, the method comprises using a video-on-demand server to intercept the access by the user of the video-on-demand service, obtain information about video content of a local cache of the video-on-demand service, obtain a profile of the user, and identify a context of the user. A customized message is constructed for the communications device based on the information about the local cache, the profile of the user, and the context of the user. The video-on-demand server sends the customized message to the communications device. In one embodiment, the user accesses the video-on-demand service through an edge base station of a core network, and the video-on-demand server is in this base station of the core network.

### BACKGROUND

This invention, generally, relates to video-on-demand services, and more specifically, to constructing a customized message for suggesting or recommending video content to a user.

Mobile communications has become very widespread, and its use is expected to increase substantially over just the next few years. A variety of devices, such as cell phones, smart phones, and personal digital assistants, are used to receive many types of data and information such as telephone calls, music and videos, including television programming and movies.

Broadband wireless technologies are widely deployed in mobile communications networks as they allow high bandwidth applications such as video-on-demand, video conferencing and other streaming applications delivered over a wireless link with both quality-of-service guarantees and adherence to security specifications. The adoption of 4G networks also encourages large numbers of participant equipment manufacture and service providers to contribute and lead in 4G ecosystem development.

With the growth of 3G/4G smart phones, backhaul links in a cellular network infrastructure are highly congested. An analysis of the traffic statistics shows multimedia (primarily video) to be one of the main causes of bandwidth congestion.

Several solutions have been proposed to ease this congestion problem. One solution is to improve the capacity of backhaul links. This, however, is costly. Another solution is to cache content at the edge of the network (e.g., base station, radio network controller, etc.). Caching effectiveness depends on the cache hit rate and approaches have been suggested that rely upon spatio-temporal locality of access to content to improve cache hit rate, and thus reduce backhaul traffic. A key problem in this approach is that locality of access, especially to rich multi-media content (e.g., movies) is not particularly strong given their cache utilization-rich content like videos occupy a lot of cache space, but do not necessarily have high hit rates.

### BRIEF SUMMARY

Embodiments of the invention provide a method, system and computer program product for creating a customized message in a video-on-demand service, in which a user accesses a site of the video-on-demand service using a communications device. In an embodiment, the method comprises using a video-on-demand server to intercept the access by the user of the site of the video-on-demand service, to obtain information about video content of a local cache of the video-on-demand server, to obtain a profile of the user, and to identify a context of the user. A customized message is constructed for the user based on the information about the video contents of the local cache, the profile of the user, and the context of the user. The video-on-demand server sends the customized message to the user.

In one embodiment, the video-on-demand service is provided by a core telecommunications network, and the user accesses the video-on-demand service through a base station of the core telecommunications network. In an embodiment, the video-on-demand server is in the base station of the core telecommunications network.

In an embodiment, the customized message is constructed using a real time analysis of the user.

In an embodiment, the context of the user is the context of the user when the user accesses the site of the video-on-demand service.

In one embodiment, the context of the user includes a defined location of the user when the user accesses the site of the video-on-demand service.

In an embodiment, when the user accesses the video-on-demand service, the user is engaged in one of a defined group of activities, and the context of the user includes said one of the defined group of activities.

In one embodiment, the video-on-demand server is used to construct the customized message for the user.

In an embodiment, the video-on-demand service is provided by a core telecommunications network, and the user accesses the video-on-demand service through a base station of the core telecommunications network. In one embodiment, the video-on-demand server is in the base station of the core telecommunications network. In an embodiment, a core server of the core telecommunications network is used to construct the customized message for the user.

In one embodiment, the video-on-demand service includes replacement policies for replacing the content in the local cache, and the method further comprises using the core server to adjust the replacement policies.

Embodiments of the invention increase the cache hit ratio of the local video cache at the base station or ratio network controller by the following: (a) offering what is already in the cache at a discount using edge analytics; and (b) tying cache replacement strategy to the backend core analytics so that multiple customers are more inclined to fetch data from the local cache.

Increased multimedia cache hit ratio will reduce backhaul congestion, generate revenue by attracting more clients that are incentivized by the discount, reduce network utilization at the remote server (like AVOD) and potentially increase sales of the multimedia content. Embodiments of the invention ease the backhaul traffic while improving the revenue for both the content provider and the cellular network service providers.

An aspect of embodiments of the invention is real time analysis (enabled by the analytics platform at the edge) of the customer seeking entertainment.

### BRIEF DESCRIPTION OF THE SEVERAL VIEWS OF THE DRAWINGS

FIG. 1 illustrates a mobile communications environment supporting a video-on-demand service using embodiments of the invention.

FIG. 2 is a flow chart showing an example implementation of an embodiment of the invention.

### DETAILED DESCRIPTION

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

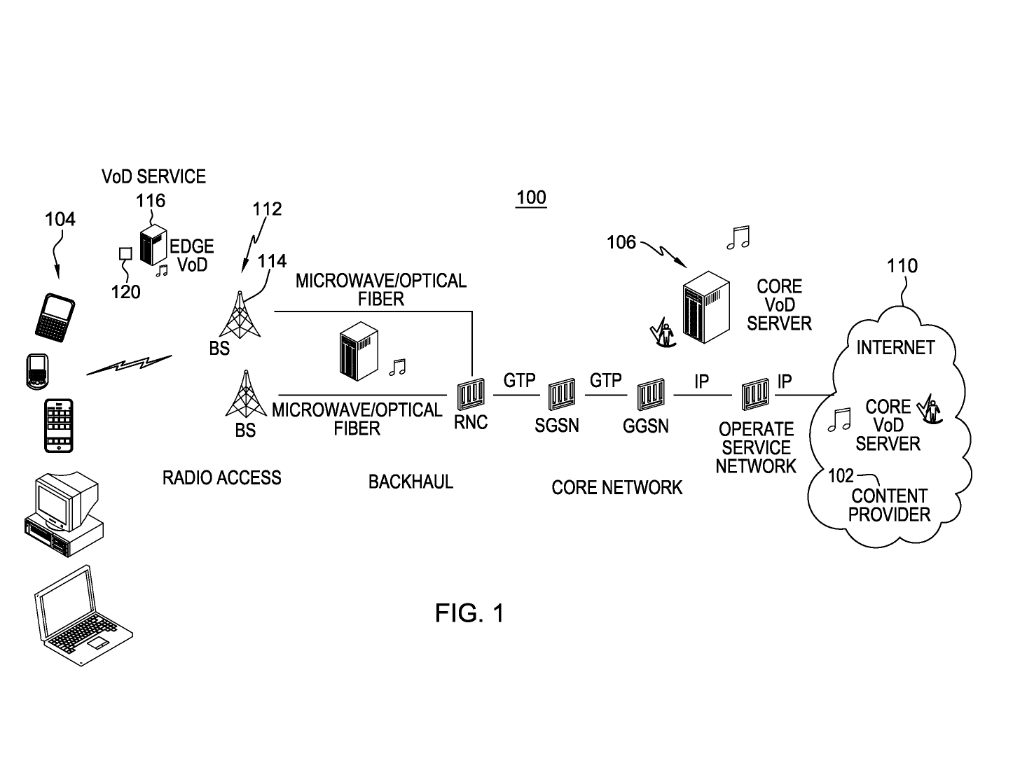

FIG. 1 illustrates a communication environment 100 supporting video-on-demand, as well as other content, including video caching and streaming, in accordance with an embodiment of the invention. The content may be provided by content providers represented at 102 and may be sent to telecommunication devices 104 via a core telecommunications network 106. In the example environment depicted in FIG. 1, the content provider 102 sends the content to the core telecommunications network 106 over a distributed network 110 such as the Internet. The core telecommunications network 106, in turn, transmits the information to the communication devices 104 through a series of base stations 112.

The core telecommunications network 106 (e.g., in an LTE architecture) is employed to facilitate communications between communication devices, such as cellular phones and laptop computers. The core telecommunications network can comprise various components, such as a Serving Gateway (SGW) and a Packet Data Network Gateway (PDN-GW), to facilitate providing connectivity for the communication devices 104 and to route data to and from those communication devices.

The core telecommunications network 106 also can allocate resources to the communication devices 104, convert or enforce protocols, establish and enforce Quality of Service (QoS) for the mobile devices, provide applications or services in the network, translate signals, and perform other desired functions to facilitate system interoperability and communications in the wireless communication network. The core telecommunications network 106 can include components such as routers, nodes, switches, interfaces, and controllers, that can facilitate communications of data between communication devices in the core telecommunications network. The core telecommunications network, as mentioned above, can include a serving gateway (SGW) that can be directly or indirectly connected to the base stations 112. The SGW can route data packets to and from the mobile devices and from and to other communication devices and also can act as a mobility anchor during inter-base station handovers and as a mobility anchor between LTE and other 3GPP technologies.

Each of the communication devices 104 is operatively connected to one of the base stations 112. Each base station serves a respective coverage area or cell, and each base station can service communication devices located in the respective area covered by the base station. The communication devices can be connected to the base stations and can communicate wirelessly using a variety of technologies, including, for example, cellular, wi-Fi, wi-Max, and wireless area networks (WLANs).

Each base station includes a radio transmitter 114, a video-on-demand server 116 and a local cache 120. The video-on-demand server is responsive to user content requests and commands and also serves to control communication with one or more remote caches and storage of video content received from the remote caches. The local cache 120 is used to store program content. Processing of normal play content received from a remote server may occur in the video-on-demand server or in the local cache. In some implementations, the local cache is implemented as a content store and includes processing logic, e.g., a CPU and control routine, responsible for performing various cache management, content storage, processing and retrieval functions as well as storage, e.g., one or more disk drives or other storage devices for storing program content.

A wide variety of communication devices 104, both mobile and stationary, may be used in embodiments of the invention. For example, mobile devices that may be used in embodiments of the invention may include portable phones, such as cell phones or the like, a smart phone, a Session Initiation Protocol (SIP) phone, a video phone, a portable email device, a thin client, or a portable gaming device. Mobile communication devices may also be, as additional examples, tablet computers and single-purpose mobile devices (such as eBooks). Stationary communication devices that may be used in embodiments of the invention include, as examples, personal computers, workstations, and laptop computers.

The communication devices 104 are in wireless communication with the core telecommunications network 106 through the base stations 112 in accordance with protocols as known by those skilled in the art. Each base station has an antenna whose radio coverage is typically tuned to a specific geographic area. As will be understood by those skilled in the art, there need not necessarily be a one-to-one correspondence between cellular towers and geographic areas, in that multiple cellular towers may cover one area and one cellular tower may cover multiple areas.

As mentioned above, in FIG. 1, the content provider is represented at 102. Many specific types of content providers that provide a wide range of specific content may use or be used in embodiments of the invention. The content provided by these providers may include video content such as television programming and movies, as well as other types of content. The content may be of various types and relate to various subjects such as, for example, entertainment, shopping, financial services, gaming, auctions, and many others.

In the example shown in FIG. 1, the content provider 102 sends information to the core telecommunications network 106 over the Internet. The Internet is a worldwide collection of computer networks and gateways that use the TCP/IP suite of protocols to communicate with one another. At the core of the Internet is a backbone of high speed data communication lines between major nodes or host computers comprised of thousands of commercial, government, education, and other computer systems that route data and messages. The present invention, it may be noted, may be implemented with a number of other types of distributed networks, such as, for example, an intranet, a local area network (LAN) or a wide area network (WAN), and the invention may be used with other protocols besides TCP (e.g., UDP, RTP, IP-in-IP (tunneling) etc.). The Internet shown in FIG. 1 is intended as an example of a distributed network and not as a limitation of the present invention.

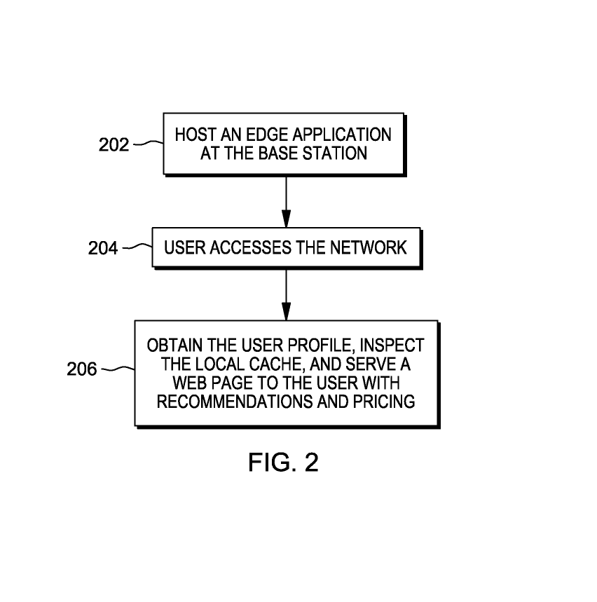

With reference to FIGS. 1 and 2, in an embodiment of the invention, as represented at 202, a video-on-demand provider hosts an edge application at the base station 112 (e.g., using the edge application infrastructure). When a user, at 204, accesses the core telecommunications network 106 and browses through information available from the core telecommunications network, this edge application, at 206, obtains a user profile from a backend server and inspects the content in the local cache 120, and the application serves a webpage to the user with recommendations and pricing.

In an embodiment of the invention, the video-on-demand application runs at the edge device to intercept customer browsing of the video-on-demand service, to obtain local cache information, and to generate a context of the user browsing. This information (user context, local cache information, browsing requests) is sent to another application (possibly at the edge) that constructs a customized webpage taking this information into account. This customized webpage is then sent to the user.

The customized message that is sent to the user may be in a form other than a webpage. For example, an audio message may be sent, or another type of video message may be sent to the user.

Embodiments of the invention increase the cache hit ratio of the local video cache at the base station or radio network controller by the following: (a) offering what is already in the cache at a discount using edge analytics; and (b) tying cache replacement strategy to the backend core analytics so that multiple customers are more inclined to fetch data from the local cache.

For illustrative purposes, assume that a customer is browsing a video-on-demand (AVOD) service. In state-of-the-art architecture today, the customer will interact with a AVOD server in the wireless core network or in the Internet. This AVOD server does not know the content of the local cache of the base station which is connected to the user, and hence recommendations, pricing, and page layout etc. to promote certain videos above others is based on a long-term static profile of the user. Typically, a proprietary algorithm will be used by the AVOD server to construct a webpage customized for the browsing customer. Once the customer makes a selection, the movie is streamed from the AVOD streaming servers which may be located in the wireless core network or in the internet.

In embodiments of the invention, the AVOD provider hosts an AVOD edge application at the base station 112 (e.g., using edge application infrastructure). This application (instead of the backend server) constructs the webpage customized for the browsing user. The edge application obtains profiling information (or any other long term static information) from the backend server, obtains the contents of the local cache from the edge services, and serves a browsing page which is optimized (by, for example, a proprietary algorithm) to maximize gains for the content provider.

The attention span and webpage real-estate constraints dictate that recommendations must be carefully matched to the long-term user profile. Also, context awareness of the browsing is likely to increase the cache hit rate—e.g., does the browsing request come from the home or from a car on a vacation trip, for example. In one embodiment, the actual analytics may still be performed at the core of the network 106, but the edge application is still needed to intercept the browsing context and fetch cache content and send this information to the server which constructs the customized webpage.

In an embodiment, procedures may be used to predict content that might be popular. For example, popularity may be predicted based on planned promotions. Also, the popularity of content in one geographical area, or among one demographic group, might be predicted based on the popularity of content in another geographical area or among a different demographic group. This information may be used to adjust the content and/or the pricing of the content in the local cache 120 and to adjust cache replacement policies so that, for example, a video which has high chances of multiple downloads either gets into the local cache 120, or if it is already in the local cache, is not purged. Adjusting the content and the pricing of the context in the local cache may increase the value of that content both to the user and to the content provider.

While it is apparent that the invention herein disclosed is well calculated to achieve the features discussed above, it will be appreciated that numerous modifications and embodiments may be devised by those skilled in the art, and it is intended that the appended claims cover all such modifications and embodiments as fall within the scope of the present invention.

1. A method of creating a customized message in a video-on-demand service to increase use of local caches, wherein a user accesses a site of the video-on-demand service using a communications device, the method comprising:
using a video-on-demand server to intercept the access by the user of the site of the video-on-demand service, to obtain information about video content of a local cache of the video-on-demand server, to obtain a profile of the user, and to identify a context of the user;
constructing a customized message for the user based on the information about the video contents of the local cache, the profile of the user, and the context of the user; and
the video-on-demand server sending the customized message to the user; and wherein:
the video-on-demand service is provided by a core telecommunications network having a base station;
the user accesses the site of the video-on-demand service by accessing the base station; of the core telecommunications network;
the local cache is in the base station; and
the customized message includes information about the video content of the local cache to increase use of the video content of the local cache by the user.

2. The method according to claim 1, wherein:
the video-on-demand server is in the base station of the core telecommunications network.

3. The method according to claim 1, wherein the constructing a customized message includes using a real time analysis of the user to construct the customized message.

4. The method according to claim 1, wherein the context of the user is the context of the user when the user accesses the site of the video-on-demand service.

5. The method according to claim 4, wherein the context of the user includes a defined location of the user when the user accesses the site of the video-on-demand service.

6. The method according to claim 1, wherein, when the user accesses the video-on-demand service, the user is engaged in one of a defined group of activities, and wherein:
the context of the user includes said one of the defined group of activities.

7. The method according to claim 1, wherein the constructing a customized message for the user includes using the video-on-demand server to construct the customized message.

8. The method according to claim 1, wherein the core telecommunications network has a core server, and the video-on-demand server is in the base station of the core telecommunications network.

9. The method to according to claim 8, wherein the constructing a customized message for the user includes using the core server to construct the customized message.

10. The method according to claim 9, wherein the video-on-demand service includes replacement policies for replacing the content in the local cache, and the method further comprises:
using the core server to adjust the replacement policies.

11. A system for creating a customized message in a video-on-demand service to increase use of local caches, wherein a user accesses a site of the video-on-demand service using a communications device, the system comprising:
one or more processing units in the video-on-demand service configured for:
intercepting the access by the user of the site of the video-on-demand service, obtaining information about video content of a local cache of the video-on-demand service, obtaining a profile of the user, and identifying a context of the user;
constructing a customized message for the user based on the information about the video contents of the local cache, the profile of the user, and the context of the user; and
sending the customized message to the user; and wherein:
the video-on-demand service is provided by a core telecommunications network having a base station;
the user accesses the site of the video-on-demand service by accessing the base station of the core telecommunications network;
the local cache is in the base station; and
the customized message includes information about the video content of the local cache to increase use of the video content of the local cache by the user.

12. The system according to claim 11, wherein:
said one or more of the processing units includes at least one video-on-demand processing unit in the base station of the core telecommunications network; and
said at least one video-on-demand processing unit performs the intercepting the access by the user of the site of the video-on-demand service, obtaining information about video content of the local cache of the video-on-demand service, obtaining the profile of the user, identifying the context of the user, and sending the customized message to the user.

13. The system according to claim 11, wherein the constructing a customized message includes using a real time analysis of the user to construct the customized message.

14. The system according to claim 11, wherein the context of the user is the context of the user when the user accesses the site of the video-on-demand service.

15. The system according to claim 14, wherein the context of the user includes a defined location of the user when the user accesses the site of the video-on-demand service.

16. An article of manufacture comprising:
at least one tangible computer readable device having computer readable program code logic tangibly embodied therein to create a customized message in a video-on-demand service to increase use of local caches, wherein a user accesses a site of the video-on-demand service using a communications device, the computer readable program code logic, when executing, performing the following:
intercepting the access by the user of the site of the video-on-demand service, obtaining information about video content of a local cache of the video-on-demand service, obtaining a profile of the user, and identifying a context of the user;
constructing a customized message for the user based on the information about the video content of the local cache, the profile of the user, and the context of the user; and
sending the customized message to the user; and wherein:
the video-on-demand service is provided by a core telecommunications network having a base station;
the user accesses the site of the video-on-demand service by accessing the base station of the core telecommunications network;
the local cache is in the base station; and
the customized message includes information about the video content of the local cache to increase use of the video content of the local cache by the user.

17. The article of manufacture according to claim 16, wherein the base station includes a video-on-demand server, and wherein:
the at least one tangible computer readable device includes a first tangible computer readable device operating on the video-on-demand server for performing the intercepting the access by the user of the site of the video-on-demand service, obtaining information about video content of the local cache of the video-on-demand service, obtaining the profile of the user, identifying the context of the user, and sending the customized message to the user.

18. The article of manufacture according to claim 16, wherein the constructing a customized message includes using a real time analysis of the user to construct the customized message.

19. The article of manufacture according to claim 16, wherein, when the user accesses the video-on-demand service, the user is engaged in one of a defined group of activities, and wherein:
the context of the user includes said one of the defined group of activities.

20. The article of manufacture according to claim 16, wherein the context of the user includes a defined location of the user when the user accesses the site of the video-on-demand service.

21. A method of creating a video display page in a video-on-demand service to increase use of local caches, wherein a user accesses the video-on-demand service using a mobile telecommunications device to browse through a site of the video-on-demand service to obtain information about the video-on-demand service, and the video-on-demand service is provided by a core telecommunications network having a base station and a video-on-demand server on said base station, the method comprising:
using the video-on-demand server to intercept the browsing by the user through the site of the video-on-demand service, to obtain information about video content of a local cache of the video-on-demand server, to obtain a profile of the user, and to identify a context of the user;
constructing a customized video display page for the user based on the information about the video contents of the local cache, the profile of the user, and the context of the user; and
the video-on-demand server sending the customized video display page to the mobile telecommunications device; and wherein:
the video-on-demand service is provided by a core telecommunications network having a base station;
the user accesses the site of the video-on-demand service by accessing the base station of the core telecommunications network;
the local cache is in the base station; and
the customized message includes information about the video content of the local cache to increase use of the video content of the local cache by the user.

22. The method according to claim 21, wherein the constructing a customized video display page includes using a real time analysis of the user to construct the customized video display page.

23. The method according to claim 21, wherein, when the user accesses the video-on-demand service, the user is engaged in one of a defined group of activities at a defined location, and wherein the context of the user includes:
the defined location of the user; and
said one of the defined group of activities.

24. The method according to claim 21, wherein the core telecommunications network includes a core server, and wherein:
the constructing a customized video display page for the user includes using the core server to construct the customized video display page.

25. The method according to claim 21, wherein the video-on-demand service includes replacement policies for replacing the content in the local cache, and the method further comprises using the core server to adjust the replacement policies.
